(19) United States
(12) Patent Application Publication
(10) Pub. No.: US 2026/0287934 A1
(43) Pub. Date: Sep. 24, 2026

(54) SMART GLASSES

(71) Applicants: Fu Tai Hua Industry (Shenzhen) Co., Ltd., Shenzhen (CN); HON HAI PRECISION INDUSTRY CO., LTD., New Taipei (TW)

(72) Inventor: RUI HE, Shenzhen (CN)

(21) Appl. No.: 19/217,049

(22) Filed: May 23, 2025

(30) Foreign Application Priority Data
Mar. 24, 2025 (CN) 202510348198.0

(51) Int. Cl. G02C 11/00; G02C 5/12

(52) U.S. Cl. CPC G02C 11/10; G02C 5/122

(57) ABSTRACT

A smart glasses includes a frame, two temples, two inflatable nose pads, and an air regulating system, the temples are respectively connected to two sides of the frame, the inflatable nose pads are respectively fixed to a middle of the frame, the air regulating system is installed on the frame and the temples, and connected to the inflatable nose pads, the air regulating system is configured to control an amount of air of the inflatable nose pads to change back and forth according to a wearing state of the smart glasses, so as to activate a massage function of the inflatable nose pads.

### CROSS-REFERENCE TO RELATED APPLICATIONS

This application claims priority to Chinese Patent Application No. 202510348198.0 filed on Mar. 24, 2025, in China National Intellectual Property Administration, the contents of which are incorporated by reference herein.

### FIELD

The subject matter herein generally relates to field of glasses technology, particularly to a smart glasses.

### BACKGROUND

Glasses are a combination of lenses and frames used to improve vision, protect the eyes or for decorative purposes. Glasses can correct a variety of vision problems, including myopia, hyperopia, astigmatism, presbyopia, strabismus or amblyopia. Glasses are usually provided with a nose pad between the two lenses. In the prior art, nose pads are mostly made of hard plastic. Such nose pads have a large contact area with the nose, so that most of the weight of the glasses is pressed on the nose. If the glasses are worn for too long, the nose will feel painful, and the wearing comfort is poor.

### BRIEF DESCRIPTION OF THE DRAWINGS

Implementations of the present disclosure will now be described, by way of embodiments, with reference to the attached figures.

FIG. 1 is a structural schematic diagram of a smart glasses provided in an embodiment of the present application.

FIG. 2 is a schematic diagram of a module of an air regulating system provided in an embodiment of the present application.

FIG. 3 is a schematic diagram of the module of the air regulating system provided in another embodiment of the present application.

FIG. 4 is a schematic diagram showing a processing of an image of an inflatable nose pad by a camera module provided in an embodiment of the present application.

FIG. 5 is a schematic diagram of the module of the air regulating system provided in another embodiment of the present application.

FIG. 6 is a structural schematic diagram of the smart glasses in a specific example of the present application.

FIG. 7 is a structural schematic diagram of the inflatable nose pad provided in an embodiment of the present application.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or another word that “substantially” modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series, and the like.

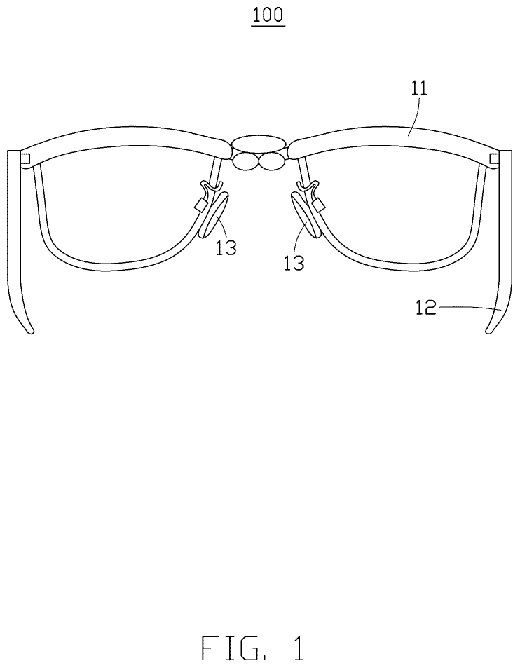

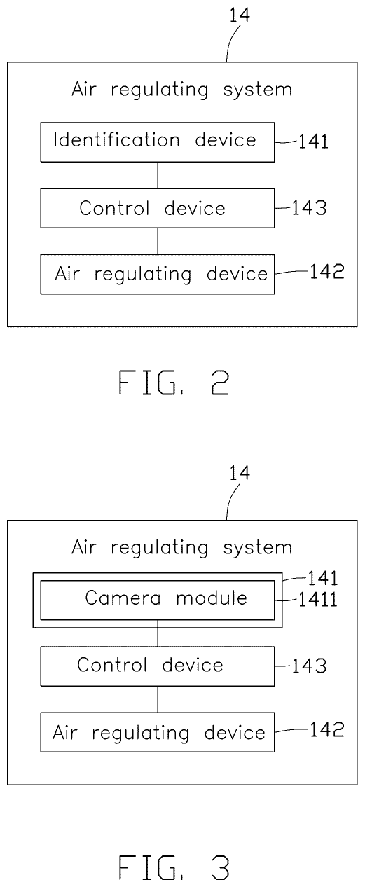

Referring to FIG. 1 and FIG. 2, which are smart glasses 100 provided in an embodiment of the present application. The smart glasses 100 include a frame 11, temples 12, inflatable nose pads 13, and an air regulating system 14.

A quantity of the temples 12 may be two, the two temples 12 are respectively connected to two sides of the frame 11. The smart glasses 100 may also include lenses, which are installed in the frame 11.

In the embodiment of the present application, the smart glasses 100 may be glasses for correcting vision, glasses for protecting eyes or for decorative purposes, or VR/AR glasses, etc. Of course, in some glasses that are only for decorative purposes, the smart glasses 100 may include lenses or may not include lenses.

A quantity of the inflatable nose pads 13 may be two, the two inflatable nose pads 13 are respectively fixed to a middle of the frame 11. In the embodiment of the present application, when the wearer wears the smart glasses 100, the two inflatable nose pads 13 respectively contact two sides of the wearer's nose.

The air regulating system 14 is installed on the frame 11 and the temples 12, and is connected to the inflatable nose pads 13. The air regulating system 14 is used to control an amount of air of the inflatable nose pads 13 to change back and forth according to the wearing state of the smart glasses 100, so as to activate the massage function of the inflatable nose pads 13.

In the embodiment of the present application, the air regulating system 14 controls the reciprocating change of the air amount in the inflatable nose pads 13, which means that the air amount in the inflatable nose pads 13 is controlled to increase and decrease repeatedly within a certain range, so that the inflatable nose pads 13 can repeatedly expand and contract, and then the inflatable nose pads 13 can massage the nose of the wearer of the smart glasses 100, thereby realizing the massage function of the inflatable nose pads 13.

In the smart glasses 100 of the embodiment of the present application, the inflatable nose pads 13 and the air regulating system 14 are provided, the air regulating system 14 is connected to the inflatable nose pads 13. The air regulating system 14 can control the reciprocating change of the amount of air in the inflatable nose pads 13 according to the wearing state of the smart glasses 100, so that the inflatable nose pads 13 can be inflated and deflated, and then the inflatable nose pads 13 can repeatedly press and release the nose of the wearer, thereby simulating a massage effect, alleviating the pain of the nose caused by wearing the smart glasses 100, and improving the wearing comfort of the smart glasses 100.

In some embodiments, as shown in FIG. 2, the air regulating system 14 includes an identification device 141, an air regulating device 142, and a control device 143.

The identification device 141 is mounted on the frame 11, and the identification device 141 is used to identify the wearing state and output relevant state information according to the identified wearing state.

The identification device 141 can be used to identify whether the smart glasses 100 are worn, a length of time the smart glasses 100 are worn, or the eyes state, nose state and other information of the wearer of the smart glasses 100.

The air regulating device 142 is connected to the inflatable nose pads 13, and the air regulating device 142 is used to adjust the amount of air in the inflatable nose pads 13.

The amount of air in the inflatable nose pads 13 is adjusted by the air regulating device 142, so that the inflatable nose pads 13 can expand and contract. When the air regulating device 142 causes the amount of air in the inflatable nose pads 13 to change back and forth, the inflatable nose pads 13 can repeatedly expand and contract to achieve the massage function of the inflatable nose pads 13.

The control device 143 is connected to the identification device 141 and the air regulating device 142. The control device 143 is used to receive the status information and control the air regulating device 142 to make the amount of air in the inflatable nose pads 13 change back and forth according to the status information.

Specifically, the control device 143 is also used to control the air regulating device 142 to make the amount of air in the inflatable nose pads 13 change back and forth after the duration of the reciprocating change of the amount of air in the inflatable nose pads 13 reaches a preset massage duration, and then stop controlling the air regulating device 142 to make the amount of air in the inflatable nose pads 13 change back and forth.

In this way, after the inflatable nose pads 13 massage the wearer's nose for the preset massage duration, the inflatable nose pads 13 stop massaging. In the embodiment of the present application, the preset massage duration can be set according to actual application requirements, for example, it can be set to 3 minutes, 5 minutes, 8 minutes, etc. The preset massage duration can be a fixed value pre-stored in the control device 143, or it can be set with different preset massage durations according to different wearing states.

In some embodiments, as shown in FIG. 3, the identification device 141 may include a camera module 1411. The camera module 1411 is used to detect the position state of the inflatable nose pads 13 in contact with the wearer's nose, and determine whether the inflatable nose pads 13 are concave and sliding downward and a sliding distance of the inflatable nose pads 13 according to the position state; when it is determined that the inflatable nose pads 13 are concave and sliding downward and the sliding distance exceeds a preset distance, the camera module 1411 outputs the state information.

When the smart glasses 100 are worn for a long time, the inflatable nose pads 13 will cause a certain indentation on the nose, and then the inflatable nose pads 13 will slide downward along the indentation. Therefore, by detecting the contact position relationship between the inflatable nose pads 13 and the wearer's nose, it can be determined whether the inflatable nose pads 13 slide downward, and then it can be confirmed whether the smart glasses 100 are worn for a long time, so as to confirm whether the wearer's nose needs to be massaged.

The camera module 1411 can be mounted in the middle of the frame 11 to detect the position of the inflatable nose pads 13 in contact with the wearer's nose. In the embodiment of the present application, the camera module 1411 can only capture images of the inflatable nose pads 13 on one side in contact with the nose.

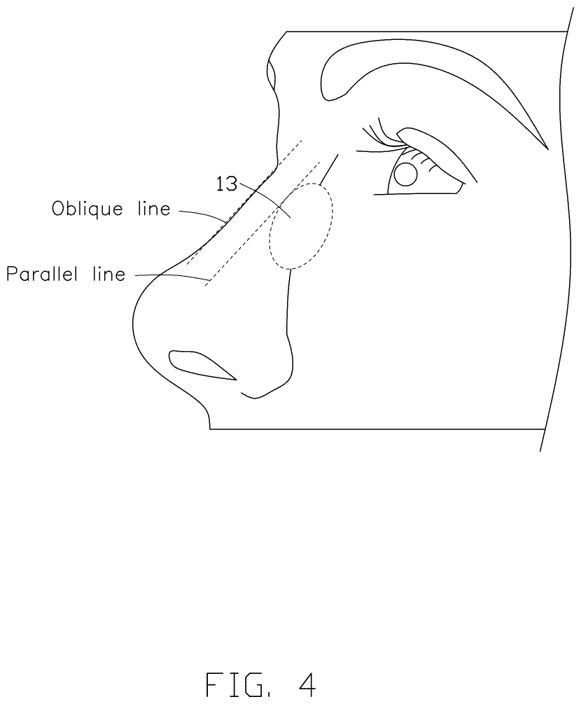

Specifically, the camera module 1411 may include a camera (not shown) and an image processor (not shown). The camera may be used to capture images of the inflatable nose pads 13 in real time and send the captured images to the image processor. The image processor processes the images and confirms the contact position between the inflatable nose pads 13 and the nose, and confirms whether the inflatable nose pads 13 are sliding downward and the sliding distance. Specifically, when the wearer initially puts on the smart glasses 100, the camera may first capture an image. When the image processor processes the image, it first draws an oblique line on the top of the nose in the image, and then draws a parallel line from the oblique line to the direction of the inflatable nose pads 13. The parallel line is connected to or tangent to the edge of the inflatable nose pads 13 (as shown by the two dotted lines in FIG. 4), and the initial distance between the oblique line and the parallel line is calculated and saved. Then, the image processor also draws oblique lines and parallel lines for each captured image, calculates the distance between the oblique lines and the parallel lines, and compares the distance with the initial distance. When the difference between the distance and the initial distance (i.e., the sliding distance) is greater than the preset distance, it is confirmed that the inflatable nose pads 13 have slid downward in a concave manner, and the image processor outputs status information indicating that the inflatable nose pads 13 have slid downward in the concave manner.

In the embodiment of the present application, the preset distance can be set to 0.3 mm, 0.5 mm, 0.6 mm, etc. In order to enable the camera to detect the slight sliding of the inflatable nose pads 13, the camera can be set as a macro camera.

In some other embodiments, the camera module 1411 can also be used to detect a number of times the wearer blinks, and determine a blink frequency according to the number of times the wearer blinks within a preset duration. When the blink frequency is less than the preset frequency, the camera module 1411 outputs the status information.

Under normal circumstances, the human eye blinks 15-20 times/min. When the wearer is immersed in watching content for a long time, the blink frequency will be reduced to 4-5 times/min. Therefore, the camera module 1411 can detect the number of blinks of the wearer and then determine the blink frequency, so as to start the massage function of the inflatable nose pads 13 when the blink frequency is low. The preset duration and the preset frequency can be set according to actual conditions. For example, the preset duration can be set to 10 minutes, 20 minutes, etc., and the preset frequency can be set to 4 times/min, 5 times/min, etc.

Similarly, an eye image of the wearer can be captured by the camera, and the image processor can confirm the number of blinks based on the eye image, and then determine the blink frequency based on the number of blinks. In the embodiment of the present application, the camera can be set as an ultra-wide-angle camera.

The camera in this embodiment and the camera for capturing the image of the inflatable nose pads 13 can be the same or different. When they are the same, the camera can be set as an ultra-Wide-angle macro camera.

In some other embodiments, the camera module 1411 can also be used to detect a congestion state of the contact position between the inflatable nose pads 13 and the wearer's nose. When it is determined that the contact position between the inflatable nose pads 13 and the wearer's nose is in the congestion state, the camera module 1411 outputs the state information.

When the smart glasses 100 are worn for a long time, the inflatable nose pads 13 will cause certain indentations on the nose of the wearer, and congestion will appear at the indentations. Therefore, it is possible to determine whether the smart glasses 100 are worn for a long time by detecting whether congestion appears at the contact position between the inflatable nose pads 13 and the nose, and then control the activation of the massage function of the inflatable nose pads 13 accordingly. In this embodiment, the camera can capture an image of the contact position between the inflatable nose pads 13 and the nose of the wearer, and the image processor processes the image to confirm whether red congestion appears at the contact position. When it is confirmed that red congestion appears at the contact position, the image processor outputs state information indicating that the contact position between the inflatable nose pads 13 and the nose is in a congested state to the control device 143.

In the present application, the camera module 1411 can simultaneously detect the position state of the inflatable nose pads 13 in contact with the wearer's nose, the number of times the wearer blinks, and the congestion state of the contact position between the inflatable nose pads 13 and the wearer's nose. When any one of the above conditions is met, the relevant status information is output to the control device 143. The control device 143 controls the air regulating device 142 to make the air volume of the inflatable nose pads 13 change back and forth to start the massage function of the inflatable nose pads 13.

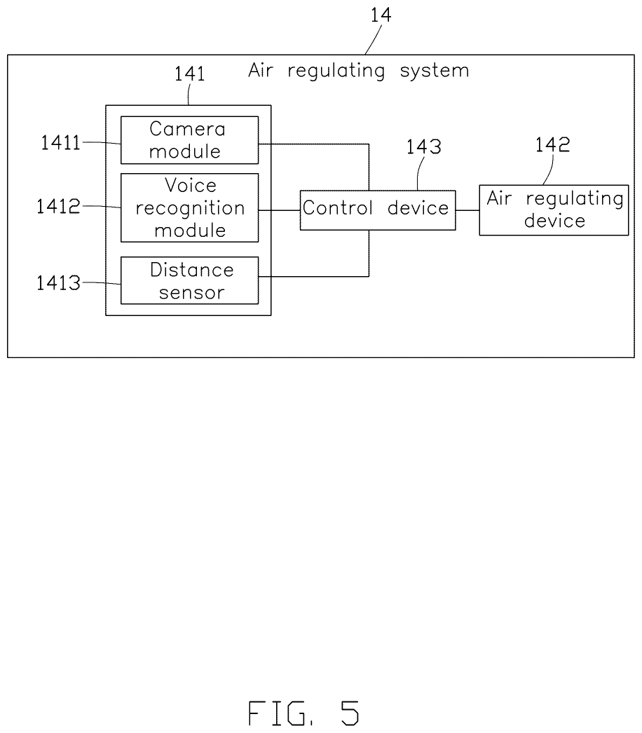

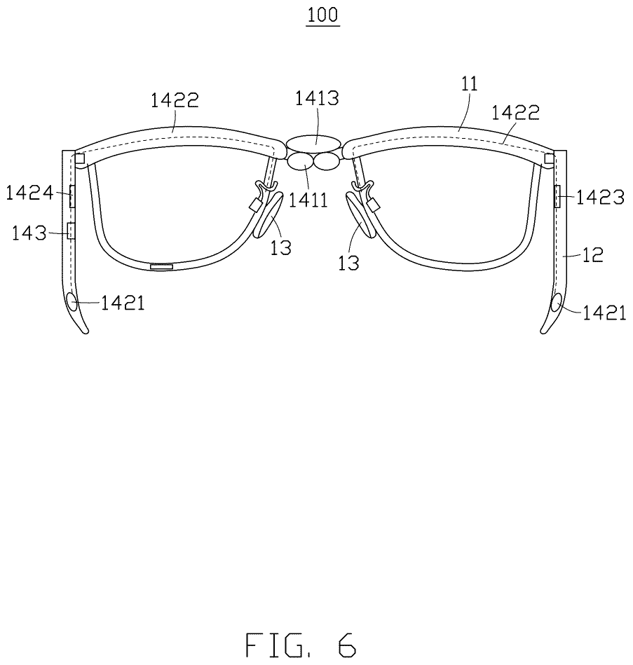

In some embodiments, as shown in FIGS. 5 and 6, the identification device 141 may further include a voice recognition module 1412. When the voice recognition module 1412 detects voice information indicating the start of the massage function, the voice recognition module 1412 outputs the status information to the control device 143.

The voice recognition module 1412 can be mounted on the frame 11. Voice information can be sent by the wearer. When the wearer feels discomfort in the nose, a voice message indicating the activation of the massage function can be sent. When the voice recognition module 1412 detects the voice information, it outputs status information to the control device 143, and then the control device 143 activates the massage function of the inflatable nose pads 13 according to the status information. In some embodiments, as shown in FIG. 5 and FIG. 6, the identification device 141 further includes a distance sensor 1413, and the distance sensor 1413 is mounted on the frame 11 near the inflatable nose pads 13. The distance sensor 1413 is used to detect whether the smart glasses 100 are worn. When it is determined that the smart glasses 100 are worn, the distance sensor 1413 sends a massage trigger signal to the control device 143, and the control device 143 is used to start timing according to the massage trigger signal. When the timing value reaches a preset timing duration, the control device 143 controls the air regulating device 142 to change the amount of air in the inflatable nose pads 13 back and forth to start the massage function.

Thus, when the smart glasses 100 are worn for a preset time, the massage function of the inflatable nose pads 13 can be automatically started.

In the above-mentioned multiple embodiments of starting the massage function, the control device 143 can stop controlling the air regulating device 142 to make the amount of air in the inflatable nose pads 13 change back and forth after the duration of the reciprocating change of the amount of air in the inflatable nose pads 13 by controlling the air regulating device 142 reaches a preset massage duration, that is, after the duration of the inflatable nose pads 13 massaging the wearer's nose reaches a preset massage duration, the inflatable nose pads 13 are controlled to stop massaging.

When the timing value reaches the preset timing duration, the control device 143 controls the massage function of the inflatable nose pads 13 to start, and resets the timing value to zero, so that the control device 143 can start the massage function of the inflatable nose pads 13 at every preset timing duration. Alternatively, the control device 143 can also reset the timing value after the massage duration of the inflatable nose pads 13 reaches the preset massage duration. Referring to FIG. 6, the air regulating device 142 includes a micro electric air pump 1421, which is mounted on any temple 12 and connected to the two inflatable nose pads 13 through air inflatable connecting tubes 1422.

The embodiment of the present application may be provided with two micro electric air pumps 1421 and two air inflatable connecting tubes 1422, and the two micro electric air pumps 1421 are respectively connected to the two inflatable nose pads 13 through the two air inflatable connecting tubes 1422. The two micro electric air pumps 1421 operate synchronously. The embodiment of the present application may also be provided with one micro electric air pump 1421, which simultaneously adjusts the amount of air in the two inflatable nose pads 13.

The control device 143 is connected to the micro electric air pump 1421, and the control device 143 is used to control the micro electric air pump 1421 to adjust the amount of air in the inflatable nose pads 13.

The air regulating device 142 also includes an inflation switch 1423 and a deflation switch 1424. The inflation switch 1423 is mounted on any temple 12 and is connected to the control device 143. When the inflation switch 1423 is pressed, an inflation trigger signal is generated to the control device 143.

The deflation switch 1424 is also mounted on any temple 12 and is connected to the control device 143. When the deflation switch 1424 is pressed, a deflation trigger signal is generated to the control device 143.

When receiving the inflation trigger signal, the control device 143 controls the micro electric air pump 1421 to inflate the air in the inflatable nose pads 13 to a preset amount. In this embodiment, when the wearer wears the smart glasses 100 or before wearing the smart glasses 100, the wearer can press the inflation switch 1423, and then the control device 143 controls the micro electric air pump 1421 to inflate the air in the inflatable nose pads 13 to a preset amount, so that the inflatable nose pads 13 expands to support the smart glasses 100 on the nose of the wearer.

The preset amount is preset by the wearer and stored in the control device 143. The preset amount can be set by the wearer according to the amount of air required for the fit between the wearer's nose and the inflatable nose pads 13, so that when the smart glasses 100 are worn, the inflatable nose pads 13 can adjust the fit with the nose, making the wearer more comfortable and less likely to slip off.

In this embodiment, when the wearer wears the smart glasses 100 for the first time, the inflatable nose pads 13 have not been inflated. The wearer can long press the inflation switch 1423 to continuously generate the inflation trigger signal to the control device 143, so that the control device 143 continuously controls the micro electric air pump 1421 to inflate the inflatable nose pads 13 until the wearer feels that the amount of air in the inflatable nose pads 13 reaches a level that makes the wearer comfortable. Then, the wearer can stop pressing the inflation switch 1423, and the control device 143 stops controlling the micro electric air pump 1421 to inflate the inflatable nose pads 13. At this time, the control device 143 records the amount of air of the inflatable nose pads 13 and uses the amount of air as the preset volume. Afterwards, when it is necessary to inflate, the wearer can press the inflation switch 1423 once, and the control device 143 directly controls the micro electric air pump 1421 to inflate the inflatable nose pads 13 according to the preset volume until the amount of air reaches the preset volume.

When receiving the deflation trigger signal, the control device 143 controls the micro electric air pump 1421 to extract the air in the inflatable nose pads 13.

The wearer can press the deflation switch 1424 when needed (for example, when not wearing the smart glasses 100) so that the deflation switch 1424 generates a deflation trigger signal to the control device 143, and then the control device 143 extracts the air in the inflatable nose pads 13 to shrink the inflatable nose pad 13.

The air regulating device 142 further includes an air pressure sensor (not shown), which is arranged in the inflatable nose pads 13 and connected to the control device 143. The air pressure sensor is used to detect the air pressure information in the inflatable nose pads 13 and send the air pressure information to the control device 143. The control device 143 is also used to control the micro electric air pump 1421 to adjust the amount of air in the inflatable nose pads 13 according to the air pressure information.

The control device 143 can confirm whether the amount of air in the inflatable nose pads 13 reaches a target amount according to the air pressure information. For example, when the control device 143 receives the inflation trigger signal, the control device 143 can confirm whether the amount of air in the inflatable nose pads 13 reaches the preset amount according to the air pressure information. When the control device 143 controls the micro electric air pump 1421 to change the amount of air in the inflatable nose pads 13 back and forth according to the state information, the control device 143 can confirm whether the amount of air reaches a maximum value or a minimum value according to the air pressure information. When it is determined that the amount of air reaches the maximum value, the control device 143 controls the micro electric air pump 1421 to reduce the air in the inflatable nose pads 13. When it is determined that the amount of air reaches the minimum value, the control device 143 controls the micro electric air pump 1421 to increase the air in the inflatable nose pads 13.

Specifically, when the control device 143 controls the micro electric air pump 1421 to change the amount of air in the inflatable nose pads 13 back and forth to achieve the massage function, the range of change of the amount of air in the inflatable nose pads 13 can be preset. For example, the range of air inflation and deflation of the inflatable nose pads 13 can be set between 20%-90%, 30%-70% or 40%-60%, which can be set according to actual needs. The control device 143 can also control the frequency of air inflation and deflation of the micro electric air pump 1421, for example, set to 10 times/min, 20 times/min, 35 times/min, etc., which can be set according to actual needs.

In addition, the control device 143 can also control the inflation and deflation speed of the inflatable nose pads 13 by the micro electric air pump 1421. For example, the inflation and deflation speed can be set to between 0.04 cm³/s and 0.5 cm³/s.

In some embodiments, the control device 143 can also determine whether the air pressure in the inflatable nose pads 13 is abnormal based on the air pressure information. When it is determined that the air pressure is abnormal, the control device 143 can control the micro electric air pump 1421 to inflate and deflate the inflatable nose pads 13 so that the air pressure in the inflatable nose pads 13 returns to normal.

In the embodiment of the present application, the identification device 141 may include the voice recognition module 1412, the camera module 1411 and the distance sensor 1413 at the same time, so that the control device 143 can control the micro electric air pump 1421 to enable the inflatable nose pads 13 to start the massage function under different circumstances.

In some embodiments, the wearer can choose the way of invoking the massage function to start when wearing the smart glasses 100. For example, in the default mode, when the distance sensor 1413 detects that the smart glasses 100 are worn, the distance sensor 1413 sends a massage trigger signal to the control device 143, and the control device 143 starts timing. When the timing reaches a preset timing duration, the control device 143 controls the micro electric air pump 1421 to start the massage function of the inflatable nose pads 13. Alternatively, in the default mode, when the voice recognition module 1412 recognizes the voice information indicating the activation of the massage function, it can output a status signal to the control device 143, so that the control device 143 controls the micro electric air pump 1421 to activate the massage function of the inflatable nose pads 13. In a seamless mode, the camera module 1411 can detect the contact position between the inflatable nose pads 13 and the wearer's nose, the congestion state or the number of times the wearer blinks, and output a status signal to the control device 143, so that the control device 143 controls the micro electric air pump 1421 according to the status information to activate the massage function of the inflatable nose pads 13.

The wearer can switch the mode by pressing the inflation switch 1423. For example, before wearing the smart glasses 100, the wearer first presses the inflation switch 1423, so that the control device 143 controls the micro-electric air pump 1421 to fill the air volume in the inflatable nose pads 13 to a preset amount, and then if the inflation switch 1423 is not pressed, the control device 143 controls the micro-electric air pump 1421 in a default mode to start the massage function of the inflatable nose pads 13. If the inflation switch 1423 is pressed again, the control device 143 controls the micro electric air pump 1421 in the seamless mode to start the massage function of the inflatable nose pads 13. Alternatively, when the inflation switch 1423 is pressed in the default mode, the control device 143 can be switched to the seamless mode; when the inflation switch 1423 is pressed in the seamless mode, the control device 143 can switch to the default mode. Alternatively, the micro electric air pump 1421 can be controlled in the default mode or the seamless mode to start the massage function of the inflatable nose pads 13 according to the pressing time of the inflation switch 1423.

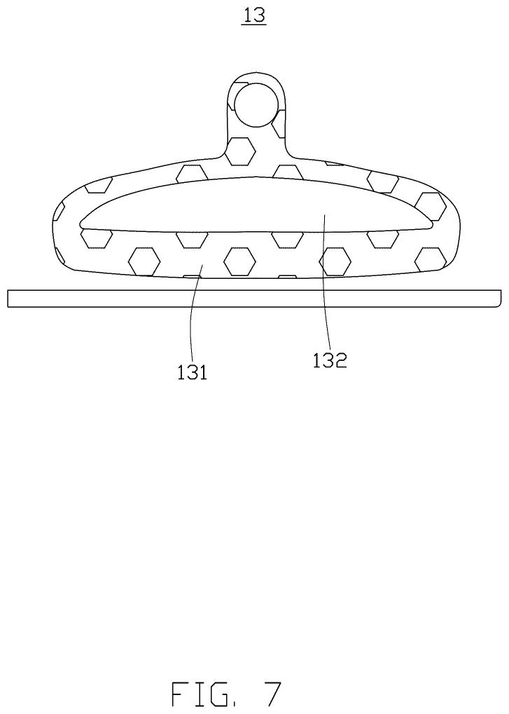

In some other embodiments, a mode switching switch (not shown) may be provided in the smart glasses 100, and the control device 143 may switch between the default mode and the seamless mode by operating the mode switching switch. In some specific examples, as shown in FIG. 7, the inflatable nose pad 13 may include a flexible contact portion 131 and an inflatable airbag 132, the flexible contact portion 131 may form an inflatable cavity, and the inflatable airbag 132 is provided in the inflatable cavity. The flexible contact portion 131 contacts the nose of the wearer. The micro electric air pump 1421 is connected to the inflatable airbag 132 through the air inflatable connecting tube 1422. The inflatable airbag 132 is inflated or deflated, so that the inflatable airbag 132 expands or contracts, and the flexible contact portion 131 expands or contracts with the inflatable airbag 132. At this time, the air pressure sensor is arranged in the inflatable airbag 132 to detect the air pressure information in the inflatable airbag 132.

In this example, a volume of the inflatable airbag 132 can be set according to actual needs, for example, it can be set to 2.0 cm³.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure, up to and including the full extent established by the broad general meaning of the terms used in the claims.

What is claimed is:

1. A smart glasses comprising:
a frame;
two temples respectively connected to two sides of the frame;
two inflatable nose pads respectively fixed to a middle of the frame; and
an air regulating system installed on the frame and the temples, and connected to the inflatable nose pads, the air regulating system is configured to control an amount of air of the inflatable nose pads to change back and forth according to a wearing state of the smart glasses, so as to activate a massage function of the inflatable nose pads.

2. The smart glasses according to claim 1, wherein the air regulating system comprises:
an identification device mounted on the frame, the identification device is configured to identify the wearing state and output relevant state information according to the identified wearing state;
an air regulating device connected to the inflatable nose pads, the air regulating device is configured to adjust the amount of air in the inflatable nose pads;
a control device connected to the identification device and the air regulating device, the control device is configured to receive the status information and control the air regulating device to make the amount of air in the inflatable nose pads change back and forth according to the status information.

3. The smart glasses according to claim 2, wherein the identification device comprises a camera module, the camera module is configured to detect a position state of the inflatable nose pads in contact with a wearer's nose, and determine whether the inflatable nose pads are concave and sliding downward and a sliding distance of the inflatable nose pads according to the position state; when it is determined that the inflatable nose pads are concave and sliding downward and the sliding distance exceeds a preset distance, the camera module outputs the state information.

4. The smart glasses according to claim 2, wherein the identification device comprises a camera module, the camera module is configured to detect a number of times the wearer blinks, and determine a blink frequency according to the number of times the wearer blinks within a preset duration, when the blink frequency is less than the preset frequency, the camera module outputs the status information; and/or
the camera module is configured to detect a congestion state of a contact position between the inflatable nose pads and the wearer's nose, when it is determined that the contact position between the inflatable nose pads and the wearer's nose is in the congestion state, the camera module outputs the state information.

5. The smart glasses according to claim 2, wherein the identification device comprises a voice recognition module, when the voice recognition module detects voice information indicating a start of the massage function, the voice recognition module outputs the status information to the control device.

6. The smart glasses according to claim 2, wherein the identification device comprises a distance sensor, the distance sensor is mounted on the frame near the inflatable nose pads, the distance sensor is configured to detect whether the smart glasses are worn, when it is determined that the smart glasses are worn, the distance sensor sends a massage trigger signal to the control device, and the control device is configured to start timing according to the massage trigger signal, when a timing value reaches a preset timing duration, the control device controls the air regulating device to change the amount of air in the inflatable nose pads back and forth to start the massage function.

7. The smart glasses according to claim 2, wherein the control device is further configured to stop controlling the air regulating device to make the amount of air in the inflatable nose pads change back and forth after the duration of a reciprocating change of the amount of air in the inflatable nose pads by controlling the air regulating device reaches a preset massage duration.

8. The smart glasses according to claim 2, wherein the air regulating device comprises a micro electric air pump, the micro electric air pump is mounted on any of the temples and connected to the two inflatable nose pads through air inflatable connecting tubes;
the control device is connected to the micro electric air pump, the control device is configured to control the micro electric air pump to adjust the amount of air in the inflatable nose pads.

9. The smart glasses according to claim 8, wherein the air regulating device comprises:
an inflation switch mounted on any of the temples and connected to the control device, when the inflation switch is pressed, an inflation trigger signal is generated to the control device;
a deflation switch mounted on any of the temples and connected to the control device, when the deflation switch is pressed, a deflation trigger signal is generated to the control device;
the control device is configured to:
control the micro electric air pump to inflate the air in the inflatable nose pads to a preset amount when receiving the inflation trigger signal, the preset amount is preset and stored in the control device;
control the micro electric air pump to extract the air in the inflatable nose pads when receiving the deflation trigger signal.

10. The smart glasses according to claim 8, wherein air regulating device further comprises an air pressure sensor, the air pressure sensor is arranged in the inflatable nose pads and connected to the control device, the air pressure sensor is configured to detect air pressure information in the inflatable nose pads and send the air pressure information to the control device, the control device is configured to control the micro electric air pump to adjust the amount of air in the inflatable nose pads according to the air pressure information.
